(19) United States
(12) Patent Application Publication
(10) Pub. No.: US 2002/0149215 A1
(43) Pub. Date: Oct. 17, 2002

(54) Litter scoop

(76) Inventor: Philip Alan McLaughlin, Nekoosa, WI (US)

Correspondence Address: George L. Williamson, P.O. Box 508, Fairhope, AL, 36533, US

(21) Appl. No.: 10/100,327

(22) Filed: Mar. 18, 2002

Related U.S. Application Data
(60) Provisional application No. 60/276,553, filed on Mar. 19, 2001.

(51) Int. Cl. A01K 29/00

(52) U.S. Cl. 294/1.3; 294/55

(57) ABSTRACT

The present invention discloses an improved litter scoop wherein the forward chamber portion of the scoop is solid and the rear portion of the scoop has slots or grating therein so that the front solid portion can be used to remove or scrape liquid type waste materials from litter and the slotted rear chamber portion can be used with solid waste so as to sift and separate litter from the solid waste materials.

This application claims benefit of U.S. Provisional Application Serial No. 60/276,553 filed on Mar. 19, 2001.

### BACKGROUND OF THE INVENTION

1. Field of the Invention

The present invention generally relates to litter scoops and, more particularly, is concerned with an improved scoop for scooping up both liquid saturated and solid material.

2. Description of the Prior Art

Litter scoops have been described in the prior art. However, none of the prior art devices disclose the unique features of the present.

In U.S. Pat. No. 5,580,111, dated Dec. 3, 1996, Bohn disclosed a device and method for handling animal waste products. Preferably, the device is used to separate animal waste products from unsoiled pet litter. In one embodiment, the device includes a waste-transferring handle that has a leading edge with an integral grate, and a trailing end that receives a removable waste-receiving receptacle. The grate includes cross members having crested upper surfaces. The spaces between the cross members define openings which retain animal waste and allow unsoiled litter to pass between. The crested upper surfaces of the cross members allow unsoiled litter to pass through the grate easily and preferably without shaking of the device.

In U.S. Pat. No. 5,829,671, dated Nov. 3, 1998, Hawk disclosed a carton functioning as a pet litter scoop, formed as a carton having a front, back, and a pair of side walls, a bottom closure for the carton, a scoop flange securing proximate the upper edge of the back wall, a pair of gussets formed between the scoop flange and the upper edges of the carton side walls, said scoop flange and gussets securing interiorly proximate the upper edge of the carton, a lid, with closure flap, pivotally connecting to the upper edge of the backwall, and when folded over holding the carton and its scoop flange into closure, a pair of lateral flaps extending from the sides of the lid, and a pair of side flanges extending from the upper edges of the side walls, all cooperating to either hold the scoop flange into its functional position, or to secure the carton into closure.

In U.S. Pat. No. 5,738,399, dated Apr. 14, 1998, Mitchell disclosed a cat litter scoop for removing waste material from scoopable cat litter. The scoop includes base portion, side panels and a back panel. The side and bottom panels are made of mesh so as to facilitate the separation of clumped waste material from cat litter The mesh is designed to allow cat litter to fall through the mesh, while waste material is contained in the scoop for disposal. The scoop is designed to more easily pick up the clumped material. The front edge of the scoop is formed so as to facilitate cleanup of the cat litter container. The handle of the scoop is designed for easier, more comfortable grasping and manipulation by the user.

In U.S. Pat. No. 5,076,627, dated Dec. 31, 1991, Simon disclosed a scoop for use in removing waste material from cat litter which comprises a shovel portion and a handle portion. The shovel portion includes a base panel, two side panels and a rear panel, with each of the panels including a multiplicity of elongated slots for straining the cat litter. The handle portion is connected to the rear panel of the shovel portion near the top and a protective shield extends downwardly from the upper surface of the rear panel at an acute angle. The protective shield extends a distance sufficient to minimize the likelihood of a person's hand from contacting cat litter as it is sifted through the slots in the rear panel.

In U.S. Pat. No. 5,711,564, dated Jan. 27, 1998, Campbell disclosed a scoop for removing animal feces from a litter box which has a channel shaped configuration to permit easy cleaning rather than a tubular shape. Also the scoop has a retaining section for holding the feces and stops them from falling out of the scoop. The apparatus has an open channel shaped scoop member with side walls having substantially in line top edges, the side walls have bottom edges joined to a base; an entry lip at one end of the scoop member is in line with the top edges of the side walls leading to a substantially flat receiving portion sloped down to the base of the scoop member. A plurality of diamond shaped sifting openings are provided in the receiving portion for sifting out litter particles, and the scoop member has a handle portion adjacent the receiving portion with a width less than the receiving portion, and an exit at the end of the scoop member opposite the entry lip, adapted to have a disposable bag attached thereto.

In U.S. Pat. No. 5,601, 321, dated Feb. 11, 1997, Simon disclosed a litter and refuse retrieval device for sanitarily and single-handedly cleaning up after a pet. The device includes an outer frame having a handle at one end and outer nipples at the other end for pivotally mounting two scoops. Each scoop includes extended disk portions with holes therethrough that overlap with the disk portions of the other scoop placing the holes in alignment for insertion of the outer nipples of the outer frame. An inner control frame is carried by the outer frame and includes linkage arms having outwardly extending cylindrical portions having nipples extending therefrom for pivotally mounting the two scoops adjacent to the outer nipples. In operation, the inner control frame is squeezed by the user toward a stop potion of the outer frame, causing the scoops to pivot in opposite directions. Also provided is a spring biasing mechanism for closing the scoops after the user has released the inner control frame.

In U.S. Pat. No. 5,238,277, dated Aug. 24, 1993, Robinson disclosed a scoop for pet litter for separating pet waste material from unsoiled clumpable pet litter. A generally planar sifter portion has a plurality of parallel ribs, defining a plurality of slots through which unsoiled pet litter is sifted. Each rib has inwardly slanting upper sides, facilitating sifting. A front member having an inwardly slanted upper exterior surface is provided, and a handle is attached to sifter portion so as to be disposed in a plane parallel to and above the sifter portion.

In U.S. Pat. No. 5,190,326, dated Mar. 2, 1993, Nunn disclosed a cat litter box cleaner which utilizes a slotted litter shovel on the end of a hand held container. The container includes a spring loaded door which permits a user to scoop up cat litter, shake the litter through the slots in the shovel, and then depress a button which releases the door so as to allow fecal material to fall into the container. A disposable plastic bag is retained within the container so as to facilitate the disposal of the waster material. The container is removable from the scoop head for purposes of removing the bag. When a bag is not used, a battery powered fan drier can be utilized to remove moisture from the fecal material before disposal.

While these litter scoops may be suitable for the purposes for which they were designed, they would not be as suitable for the purposes of the present invention, as hereinafter described.

### SUMMARY OF THE INVENTION

The present invention discloses an improved litter scoop wherein the forward chamber portion of the scoop is solid and the rear portion of the scoop has slots or grating therein so that the front solid portion can be used to remove or scrape liquid type waste materials from litter and the slotted rear chamber portion can be used with solid waste so as to sift and separate litter from the solid waste materials.

An object of the present invention is to provide a litter scoop tool that can be used with both wet litter and dry litter. A further object of the present invention is to provide a litter scoop wherein the wet litter will not fall through the scoop. A further object of the present invention is to provide a litter scoop that will remove urine soaked litter so that the litter in the litter pan will not have to be changed as frequently, thereby saving time and money.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views. For a definition of the complete scope of the invention, the reader is directed to the appended claims.

### BRIEF DESCRIPTION OF THE DRAWINGS

In order that the invention may be more fully understood, it will now be described, by way of example, with reference to the accompanying drawings in which:

FIG. 1 is a plan view of the present invention.

FIG. 2 is a side elevation view of the present invention.

FIG. 3 is a perspective view of the present invention.

### LIST OF REFERENCE NUMERALS

With regard to reference numerals used, the following numbering is used throughout the drawings.

10 present invention

12 scoop

14 handle

16 lip

18 solid area/front portion

20 slotted area/rear portion

22 side wall

24 solid area

26 slotted area

28 rounded corners

### DESCRIPTION OF THE PREFERRED EMBODIMENT(S)

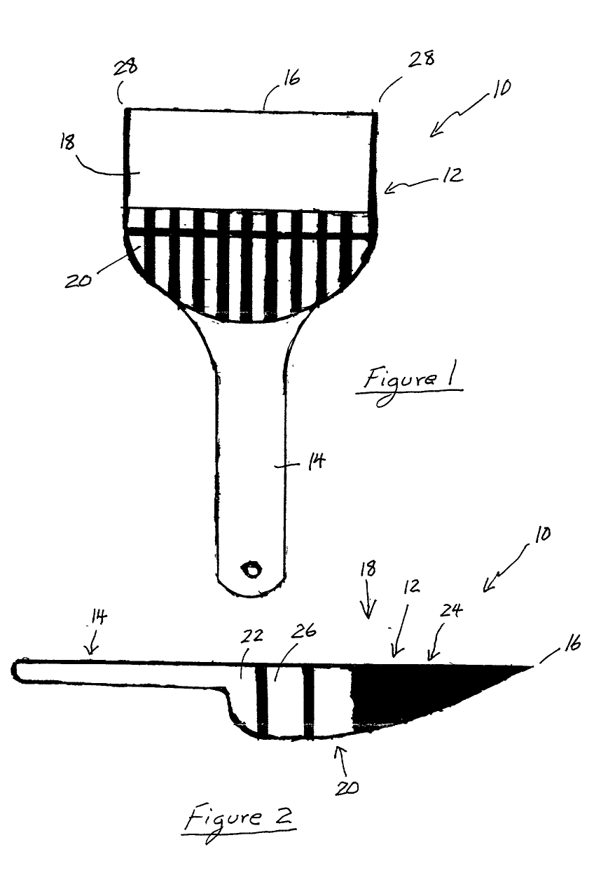

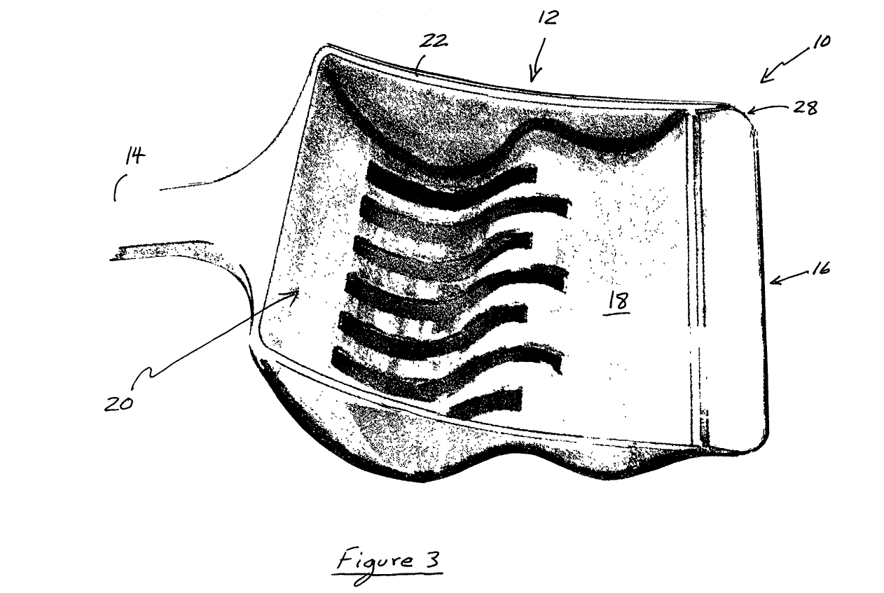

In order that the invention may be more fully understood, it will now be described, by way of example, with reference to the accompanying drawings in which FIGS. 1 through 2 illustrate the present invention wherein an improved litter scoop is disclosed.

Turning to FIG. 1, therein is shown a plan view of the present invention 10 having a forward scoop portion 12 and a rear handle portion 14 which handle portion is designed to be grasped in the hand of a user and used in a conventional manner. The scoop portion 12 of the present invention 10 has a forward lip 16 and a generally forward portion 18 which is a solid portion having no slot or grate therein and comprising approximately one-half the total size of the scoop 12. The rear portion of the scoop 12 is made of a plurality of slots or grates 20 as would be done in the standard manner by one skilled in the art.

Turning to FIG. 2, therein is shown a side elevation view of the present invention having a forward scoop portion 12 and a rear handle portion 14. The scoop portion of the present invention 10 has a forward lip 16 and a generally forward portion 18 which is a solid portion having no slot therein and comprising approximately one-half the total size of the scoop 12. The rear portion of the scoop 12 is made of a plurality of slots 20 as would be done in the standard manner by one skilled in the art. It should be clear that the side walls 22 of the scoop have a forward area 24 of the side walls which is solid in construction and a rear portion 26 of the side walls which is slotted in structure which solid and slotted areas are complementarily spaced as the solid and slotted areas as seen in FIG. 1 of the scoop 12.

FIG. 3 is a perspective view of the present invention showing the elements previously disclosed. Shown are the smaller front chamber portion 18 without slots and the larger rear chamber portion 20 which has slots therein.

It should be seen that in operation by constructing a forward portion 18 of the scoop 12 in a solid manner being approximately 50% of the scoop 12 thereby the tool can be effectively used to remove both solid or feces and liquid or urine deposits. The rear area 20 of the tool is slotted to sift out waste generated from solid waste as loose litter passes through the slots and the front area 18 of the tool will effectively remove waste material generated from liquid waste. This is important because if urine waste is not effectively removed from the litter bed, it will contaminate the remaining litter in the litter pan. Effective removal of both solid and liquid waste will save both time and money, and the pan will require less washing and less litter will be needed because the litter being used will last longer.

The most efficient usage of the tool of the present invention 10 is achieved when the litter pan is lifted at one end such that the dry litter slides to the other end, thus isolating and exposing any wet litter. The wet litter is removed, the pan is then tipped in the opposite direction and the wet litter is removed. The solid waste is then sifted out as loose litter is allowed to pass through the slots. The idea is that when the litter pan is tipped to a slight angle, the dry litter will slide leaving the wet litter behind. The solid portion of the present invention will remove the wet litter easily and the slotted area of the present invention allows the solid materials to be sifted out.

The tool is effective when used with all types of litter.

It should be noted that having rounded corners in FIG. 1 at 28 on the scooping end of the tool 10 will allow maximum effectiveness in cleaning the bottom including corners of the standard litter pan because litter pans generally have a curved surface in the transition area between the sides and bottom of the pan.

What is claimed to be new and desired to be protected by Letters Patent is set forth in the appended claims.

I claim:

1. An apparatus for a scoop for scooping up and separating animal litter and animal waste, comprising:
a) a scoop portion, said scoop portion having a forward edge, a rear edge, a pair of side walls, and a bottom;
b) a front chamber disposed over about one-half of said scoop portion, said front chamber being adjacent said front edge to permit animal waste to be scooped up and contained therein;
c) a rear chamber disposed over about one-half of said scoop portion, said rear chamber being adjacent said rear edge to permit animal waste to be scooped up and contained therein; and,
d) a handle disposed on said rear edge of said scoop to permit a user to grasp the apparatus.

2. The apparatus of claim 1, wherein said bottom and said side walls of said front chamber are solid to permit animal waste to be scooped up and contained therein.

3. The apparatus of claim 2, wherein said bottom of said rear chamber has a plurality of slots disposed therein to permit animal waste to be scooped up and contained therein and animal litter to pass therethrough.

4. The apparatus of claim 3, wherein said slots are spaced apart about said bottom of said rear chamber.

5. The apparatus of claim 4, wherein said sidewalls of said rear chamber has a plurality of slots disposed therein to permit animal waste to be scooped up and contained therein and animal litter to pass therethrough.

6. The apparatus of claim 5, wherein said slots are spaced apart about said sidewalls of said rear chamber.

7. The apparatus of claim 6, further comprising a lip disposed on said forward edge of said scoop portion to permit animal waste to be easily scooped up.

8. The apparatus of claim 7, wherein said rear chamber is larger than said front chamber to permit large pieces of animal waste to be scooped up and contained therein and animal litter to pass therethrough.
